(19) United States
(12) Patent Application Publication
(10) Pub. No.: US 2021/0296794 A1
(43) Pub. Date: Sep. 23, 2021

(54) TERMINAL-MOUNTED ELECTRICAL WIRE AND TERMINAL FITTING

(71) Applicant: Yazaki Corporation, Tokyo (JP)

(72) Inventor: Masanori Onuma, Shizuoka (JP)

(21) Appl. No.: 17/199,410

(22) Filed: Mar. 11, 2021

(30) Foreign Application Priority Data
Mar. 18, 2020 (JP) 2020-047457

(51) Int. Cl. H01R 4/18; H01R 4/70; H01R 43/00

(52) U.S. Cl. CPC H01R 4/185; H01R 43/005; H01R 4/70

(57) ABSTRACT

A terminal-mounted electrical wire includes: an electrical wire including a stripped portion formed on the end and a sheath; a terminal fitting having a core connection body physically and electrically connected to a stripped portion, and a sheath connection body physically connected to a sheath end portion of a sheath formed on the end of the electrical wire, spaced from each other in the axial direction of the electrical wire; and a water-blocking member to externally cover an exposed portion, outwardly exposed, on the stripped portion connected with the core connection body.

### CROSS-REFERENCE TO RELATED APPLICATION(S)

The present application claims priority to and incorporates by reference the entire contents of Japanese Patent Application No. 2020-047457 filed in Japan on Mar. 18, 2020.

### BACKGROUND OF THE INVENTION

### 1. Field of the Invention

The present invention relates to a terminal-mounted electrical wire and a terminal fitting.

### 2. Description of the Related Art

Conventional known terminal-mounted electrical wires have a barrel piece for a core of a terminal fitting crimped to the core (stripped portion), which is an end portion of the electrical wire where the electrical wire is stripped to the core, and a barrel piece for sheath of the terminal fitting crimped to an end portion of the sheath of the electrical wire. This type of terminal-mounted electrical wire is described in, for example, Japanese Patent Application Laid-open No. 2015-79750 and Japanese Patent Application Laid-open No. 2018-6205.

A conventional terminal-mounted electrical wire includes such a terminal fitting having a barrel piece for core and a barrel piece for sheath spaced from each other in an axis direction of the electrical wire. In this structure, the tip end of the core, and a portion between the barrel piece for core and the barrel piece for sheath at the stripped portion are exposed. On the terminal-mounted electrical wire, for example, as described in Japanese Patent Application Laid-open No. 2018-6205, the exposed portion of the stripped portion and the terminal fitting are externally covered together with resin, so as to keep water from entering a gap between the stripped portion and the terminal fitting and to protect the electrical wire from corrosion.

In such a conventional terminal-mounted electrical wire, however, the end of the sheath closer to the stripped portion is arranged to project to the space between the barrel piece for core and the barrel piece for sheath, with the intention to prevent an improper joint between the end of the sheath and the barrel piece for sheath. This structure may cause the end of the sheath to be lifted and separate from the core, when the barrel piece for sheath is crimped to the sheath. The lifted end of the sheath prevents a water-blocking member, such as resin, from properly covering the exposed portion of the stripped portion and the terminal fitting, which reduces the effect of preventing corrosion of the terminal-mounted electrical wire. As described above, a conventional terminal-mounted electrical wire has an issue in that maintaining a proper joint of the terminal fitting to the end of the electrical wire may impair the effect of preventing corrosion.

Japanese Patent Application Laid-open No. 2018-92739 describes such a terminal-mounted electrical wire that includes an integrated barrel piece in which a barrel piece for core and a barrel piece for sheath are integrally formed, and has a hole at the rear end of the integrated barrel piece closer to the sheath. The sheath is set to bite into the hole, to prevent move of the sheath to the compressed area and accordingly to protect the terminal-mounted electrical wire from water.

### SUMMARY OF THE INVENTION

The present invention therefore aims to provide a terminal-mounted electrical wire and a terminal fitting that can effectively reduce corrosion while maintaining a proper joint of the terminal fitting to the end of the electrical wire.

To solve the problem, a terminal-mounted electrical wire according to one aspect of the present invention includes an electrical wire including a stripped portion located on an end, and a sheath that covers a portion of a core other than the stripped portion; a terminal fitting having a core connection body configured to be physically and electrically connected with the stripped portion, and a sheath connection body physically connected with a sheath end portion of the sheath on the end of the electrical wire, spaced from each other in an axial direction of the electrical wire; and a water-blocking member that covers an exposed portion, outwardly exposed, of the stripped portion connected to the core connection body, wherein the sheath connection body includes a bottom on which the sheath end portion is placed, and a pair of barrel pieces standing from respective ends, of the bottom, aligned in a direction perpendicular to the axial direction and configured to be crimped to the sheath end portion inside, the sheath end portion not projecting toward the core connection body, and an end, of at least one of the two barrel pieces, closer to the core connection body has a through-hole through which the sheath end portion subjected to crimping is allowed to be visually observed from outside.

According to another aspect of the present invention, in the terminal-mounted electrical wire, it is preferable that the sheath end portion and the two barrel pieces subjected to crimping are disposed such that respective end surfaces, facing the core connection body, are flush with each other.

According to still another aspect of the present invention, in the terminal-mounted electrical wire, it is preferable that the water-blocking member externally covers an end, of the two barrel pieces, closer to the core connection body, and the through-hole is formed on a portion of an end closer to the core connection body of at least one of the two barrel pieces, the portion being not covered by the water-blocking member.

According to still another aspect of the present invention, in the terminal-mounted electrical wire, it is preferable that the water-blocking member externally covers an end, of the two barrel pieces, closer to the core connection body, and the through-hole is formed to allow the sheath end portion subjected to crimping to be visually observed from outside, at least until the end of the two barrel pieces, closer to the core connection body, is covered by the water-blocking member.

To solve the problem, a terminal fitting according to still another aspect of the present invention includes a core connection body configured to be physically and electrically connected with a stripped portion formed on an end of an electrical wire; and a sheath connection body spaced from the core connection body in an axial direction of the electrical wire and configured to be physically connected with a sheath end portion of a sheath formed on an end of the electrical wire, wherein the sheath connection body includes a bottom on which the sheath end portion is placed and a pair of barrel pieces standing from respective ends, of the bottom, aligned in a direction perpendicular to the axial direction and configured to be crimped to the sheath end portion inside, the sheath end portion not projecting toward the core connection body, and an end, of at least one of the two barrel pieces, closer to the core connection body has a through-hole through which the sheath end portion subjected to crimping is allowed to be visually observed from outside.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of a terminal-mounted electrical wire (excluding a water-blocking member) of an embodiment;

FIG. 2 is a plan view of the terminal-mounted electrical wire according to the embodiment;

FIG. 3 is a cross-sectional view of FIG. 2 along X-X line;

FIG. 4 is a drawing that illustrates the cross-sectional view of FIG. 2 along Y1-Y1 line turned counterclockwise by 90 degrees; and

FIG. 5 is a drawing that illustrates the cross-sectional view of FIG. 2 along Y2-Y2 line turned counterclockwise by 90 degrees.

### DETAILED DESCRIPTION OF THE PREFERRED EMBODIMENTS

Embodiments of a terminal-mounted electrical wire and a terminal fitting according to the present invention will now be described with reference to the drawings. It should be noted that the embodiment is not intended to limit the present invention.

### Embodiment

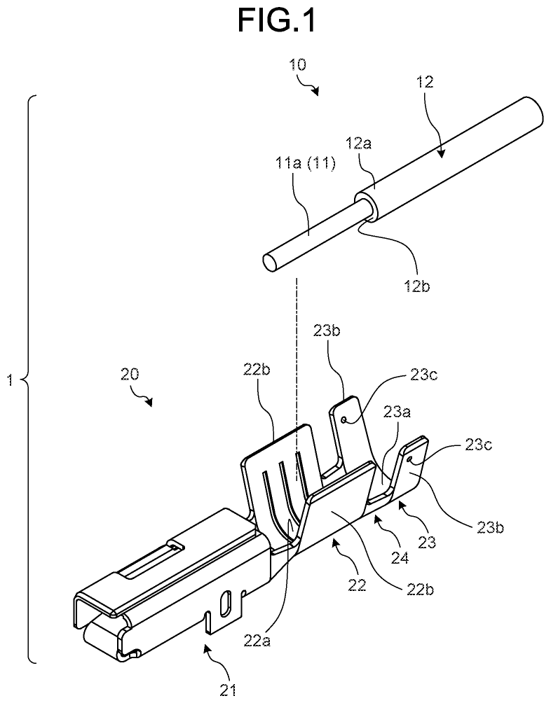

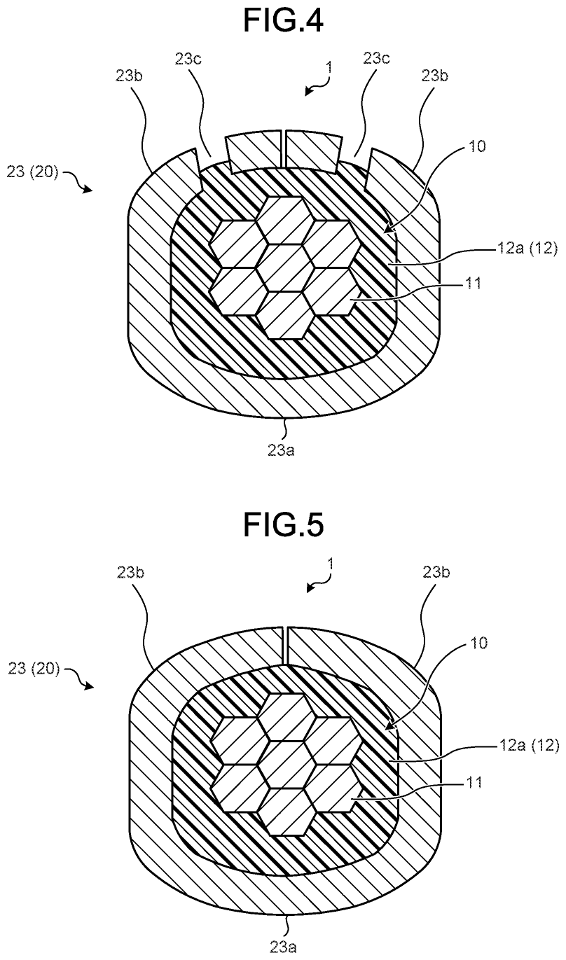

An embodiment of a terminal-mounted electrical wire and a terminal fitting according to the present invention will now be described with reference to FIG. 1 to FIG. 5.

A terminal-mounted electrical wire 1 includes an electrical wire 10 and a terminal fitting 20 (FIG. 1) configured to be physically and electrically connected with each other.

The electrical wire 10 includes a core 11 and a sheath 12 that externally covers the core 11. At the end of the electrical wire 10, the sheath 12 is stripped to the core 11 (FIG. 1). In other words, the electrical wire 10 has an end portion where the sheath 12 is stripped to the core 11 (hereinafter, “stripped portion 11a”) and portions other than the stripped portion 11a where the sheath 12 covers the core 11. The core 11 may be a columnar bundle of strands, each of which is made of conductive metal wires, or may be a rod-shaped conductor formed in a columnar shape. In this example, the core 11 is made of a plurality of wires.

The terminal fitting 20 is formed of a conductive material such as metal. The terminal fitting 20 includes a terminal connection body 21 configured to be physically and electrically connected with a terminal connection body (not illustrated) of a counterpart terminal fitting, a core connection body 22 configured to be physically and electrically connected with a stripped portion 11a formed on the end of the electrical wire 10, and a sheath connection body 23 to be physically connected with a sheath end portion 12a of the sheath 12 on the end of the electrical wire 10 (FIG. 1). On the terminal fitting 20, the core connection body 22 and the sheath connection body 23 are spaced from each other in an axial direction of the electrical wire 10. The terminal fitting 20 thus includes a joint 24 for connection between the core connection body 22 and the sheath connection body 23 spaced from each other. Specifically, the joint 24 connects respective bottoms 22a and 23a, which will be described later, of the core connection body 22 and the sheath connection body 23.

For example, either the terminal connection body 21 of the terminal fitting 20 or a terminal connection body of a counterpart terminal fitting is a female connector, and the remaining is a male connector to be inserted to the other and mate therewith. In this example, the terminal connection body 21 of the terminal fitting 20 is a female connector, and the terminal connection body of the counterpart terminal fitting is a male connector.

The core connection body 22 includes the bottom 22a on which the stripped portion 11a is placed and a pair of barrel pieces 22b standing from the respective ends, of the bottom 22a, being aligned in a direction perpendicular to the axial direction of the electrical wire 10 (FIG. 1). The two barrel pieces 22b are kept spaced from each other in the direction perpendicular to the axial direction of the electrical wire 10, until connection with the stripped portion 11a. The example core connection body 22 before connection is in a U-shape having an arcuate bottom 22a and the pair of barrel pieces 22b.

In the core connection body 22 before connection, the stripped portion 11a is placed on the bottom 22a in a space surrounded by the bottom 22a and the pair of barrel pieces 22b. The core connection body 22 is physically and electrically connected with the stripped portion 11a by externally applying force to the bottom 22a and the pair of barrel pieces 22b while the pair of barrel pieces 22b being wrapped around and crimped to the stripped portion 11a inside. The core connection body 22 is crimped so as to be shaped into a columnar, which is what is called, round crimping shape having the end surfaces of the respective barrel pieces 22b in the direction of standing in abutment with each other.

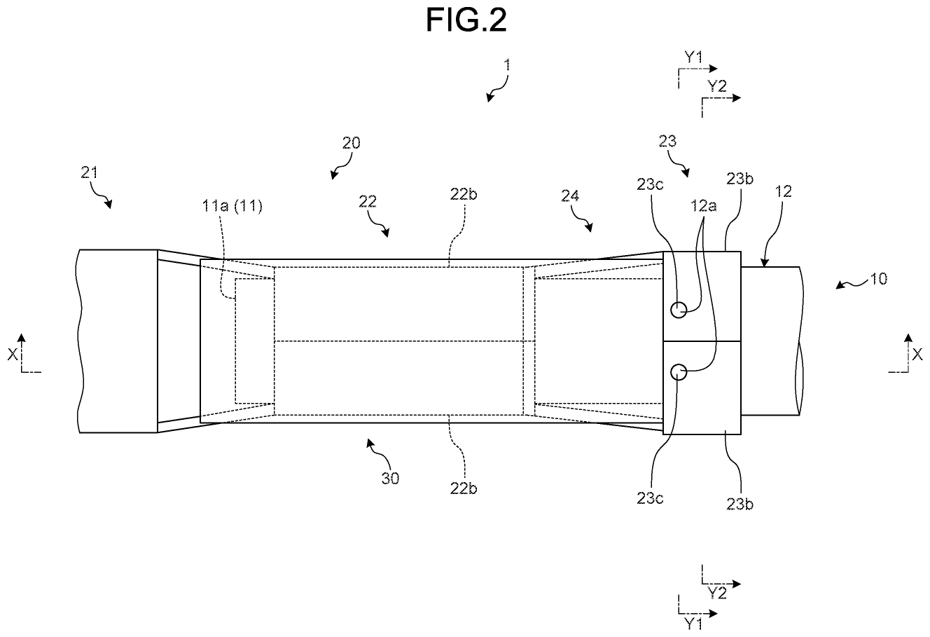

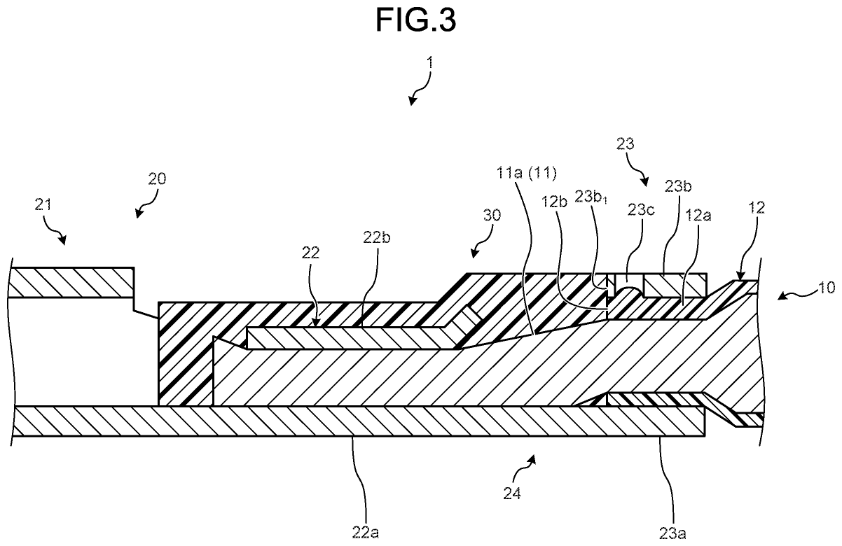

The stripped portion 11a has its tip end projecting out of the core connection body 22 toward the terminal connection body 21 after crimping (FIG. 2 and FIG. 3).

The sheath connection body 23 includes the bottom 23a on which the sheath end portion 12a is placed and a pair of barrel pieces 23b standing from the respective ends, of the bottom 23a, being aligned in a direction perpendicular to the axial direction of the electrical wire 10 (FIGS. 1, 4 and 5). As with the core connection body 22, the two barrel pieces 23b are kept spaced from each other in the direction perpendicular to the axial direction of the electrical wire 10 until connection with the sheath end portion 12a. The sheath connection body 23 before connection may be in any shape that has the bottom 23a and the pair of barrel pieces 23b. For example, this sheath connection body 23 before connection is in a U-shape having an arcuate bottom 23a and the pair of barrel pieces 23b.

As with the core connection body 22, for connection, the sheath end portion 12a is placed on the bottom 23a in a space surrounded by the bottom 23a and the pair of barrel pieces 23b, of the sheath connection body 23. The sheath connection body 23 is physically and electrically connected with the sheath end portion 12a by externally applying force to the bottom 23a and the pair of barrel pieces 23b while the pair of barrel pieces 23b being wrapped around and crimped to the sheath end portion 12a inside.

The sheath connection body 23 after crimping may be in any desired shape known in this technical field. For example, the sheath connection body 23 may be crimped so as to be in a B-shape, what is called, B-shaped crimping, or in a D-shape, called D-shaped crimping, or may be in such a shape called overlap crimping that has an overlap area where the outer wall surface of one of the barrel pieces 23b is overlapped by the inner wall surface of the other barrel piece 23b. The sheath connection body 23 of this example is crimped so as to be a columnar, which is what is called, round crimping shape having the end surfaces of the barrel pieces 23b in the direction of standing in abutment with each other.

The stripped portion 11a of the terminal-mounted electrical wire 1 has its tip end exposed out of the above core connection body 22 toward the terminal connection body 21, and also has a portion outwardly exposed between the core connection body 22 and the sheath connection body 23. For this structure, the terminal-mounted electrical wire 1 includes a water-blocking member 30 (FIG. 2 and FIG. 3). With the stripped portion 11a in connection with the core connection body 22, the water-blocking member 30 externally covers the exposed portions, outwardly exposed, on the stripped portion 11a and blocks water from entering a gap between the exposed portion of the stripped portion 11a and the terminal fitting 20.

The water-blocking member 30 is made by, for example, solidifying a fluid, such as liquid, synthetic resin material. After crimping of the terminal fitting 20 to the electrical wire 10, the water-blocking member 30 is formed on the terminal-mounted electrical wire 1 by applying the fluid synthetic resin material to the exposed portions of the stripped portion 11a and solidifying the synthetic resin material. The water-blocking member 30 may be in any form if it externally covers at least the exposed portions of the stripped portion 11a. This example water-blocking member 30 externally covers the exposed portions of the stripped portion 11a together with the core connection body 22. It is more preferable that the water-blocking member 30 externally cover the ends, of the pair of barrel pieces 23b of the sheath connection body 23, closer to the core connection body 22, not to allow a gap to be produced between end surfaces 23b₁ of the barrel pieces 23b and the water-blocking member 30.

Conventional types of terminal-mounted electrical wire has the sheath end portion after crimpling projecting out of the end surfaces of a pair of barrel pieces of the sheath connection body toward the core connection body, thereby ensuring a contact area required between the sheath end portion and the sheath connection body, and maintaining a proper joint therebetween.

However, as described earlier, the projecting portion of the sheath end portion may be lifted from the core when the sheath connection body is crimped. The lifted projecting portion of the sheath end portion may cause the applied synthetic resin material to runoff to the peripheral areas due to its fluidity. When the synthetic resin material solidifies to be a water-blocking member, the areas may fail to be externally covered by the water-blocking member. Furthermore, with the projecting portion of the sheath end portion lifted, a gap is produced between the projecting portion and the core. This gap generates bubbles during application of the synthetic resin material, and the bubbles wash out the synthetic resin material to the peripheral areas. When the synthetic resin material solidifies to be a water-blocking member, the lifted projecting portion may fail to be externally covered with the water-blocking member. As above, in conventional types of terminal-mounted electrical wire, the exposed portion on the stripped portion may fail to be entirely covered with the water-blocking member.

For this issue, the terminal-mounted electrical wire 1 of the embodiment has the sheath end portion 12a after crimping not projecting out of the end surfaces 23b₁ of the pair of barrel pieces 23b of the sheath connection body 23 toward the core connection body 22, regardless of the shape of the sheath connection body 23 after crimping. The sheath connection body 23 is crimped to the sheath end portion 12a inside, with the sheath end portion 12a not projecting toward the core connection body 22. For this connection, the pair of barrel pieces 23b of the sheath connection body 23 is in a shape, for example, that allows the barrel pieces 23b to be crimped to the sheath end portion 12a inside, with the sheath end portion 12a not projecting toward the core connection body 22. The sheath end portion 12a is set on the bottom 23a of the sheath connection body 23, taking the amount of extension in the axial direction after crimping of the sheath connection body 23 into consideration. In this example, the sheath end portion 12a and two barrel pieces 23b subjected to crimping are disposed such that the respective end surfaces 12b and 23b₁, facing the core connection body, are flush with each other (FIG. 3). This structure of the terminal-mounted electrical wire 1 can reduce a gap between the stripped portion 11a and the sheath connection body 23, and thus can reduce bubbles that are generated in the gap during application of the synthetic resin material.

The terminal-mounted electrical wire 1 of this embodiment has the sheath end portion 12a not projecting out of the end surfaces 23b1 of the pair of barrel pieces 23b of the sheath connection body 23 toward the core connection body 22. This structure can keep the sheath end portion 12a from being lifted at the end thereof closer to the core connection body 22. In the terminal-mounted electrical wire 1, exposed portions on the stripped portion 11a are entirely covered with the water-blocking member 30, which keeps water from entering a gap between the exposed portions on the stripped portion 11a and the terminal fitting 20. The terminal-mounted electrical wire 1 is therefore further protected from corrosion.

Meanwhile, the above structure of the terminal-mounted electrical wire 1 has the sheath end portion 12a not projecting out of the sheath connection body 23 toward the core connection body 22, and this makes it difficult to check the presence of a necessary contact area between the sheath connection body 23 and the sheath end portion 12a. For this issue, the terminal-mounted electrical wire 1 of the embodiment has a through-hole 23c through which the sheath end portion 12a subjected to crimping is visually observed, at an end closer to the core connection body 22 of at least one of two barrel pieces 23b of the sheath connection body 23 (FIG. 1 to FIG. 4). If the sheath end portion 12a is, for example, visually observed through the through-hole 23c, the operator or the like of the terminal-mounted electrical wire 1 can confirm that a necessary contact area is maintained between the sheath connection body 23 and the sheath end portion 12a and that these parts are properly joined to each other. If the sheath end portion 12a is not, for example, visually observed through the through-hole 23c, the operator or the like of the terminal-mounted electrical wire 1 can determine the absence of a necessary contact area between the sheath connection body 23 and the sheath end portion 12a.

In this example, the through-hole 23c is circular. Without being limited thereto, the through-hole 23c may be in any shape, such as a polygon, that allows the operator to visually observe the sheath end portion 12a.

The through-hole 23c is formed on an end, of at least one of two barrel pieces 23b of the sheath connection body 23, closer to the core connection body 22. More specifically, the through-hole 23c is formed where the inner wall surface of the barrel piece 23b is directly in contact with the sheath end portion 12a and where the outer wall surface of the barrel piece 23b is not overlapped by the inner wall surface of the other barrel piece 23b. If the sheath connection body 23 is crimped in the form of overlap crimping, described earlier, the through-hole 23c is formed at a location excluding the overlap area on the barrel piece 23b. At least one through-hole 23c is formed for the barrel pieces 23b. In this example, the through-hole 23c is formed on each of the barrel pieces 23b.

The water-blocking member 30 externally covers the ends, closer to the core connection body 22, of the two barrel pieces 23b of the sheath connection body 23. In this structure, the through-hole 23c is formed as below.

For example, the through-hole 23c may be formed on the end, of at least one of two barrel pieces 23b of the sheath connection body 23, closer to the core connection body 22, particularly, at a location not covered by the water-blocking member 30. In this structure of the terminal-mounted electrical wire 1, the operator is allowed to determine the presence or absence of a necessary contact area between the sheath connection body 23 and the sheath end portion 12a, even after formation of the water-blocking member 30. In this case, however, the through-hole 23c needs to be shifted in a direction in which the electrical wire 10 is pulled back from the sheath connection body 23 by a distance corresponding to the size of the water-blocking member 30 in the axial direction (the axial direction of the electrical wire), formed on the sheath connection body 23. This may increase the size of the terminal fitting 20.

For this issue, the through-hole 23c may be formed such that the sheath end portion 12a subjected to crimping is visually observed from outside, at least until the ends of the two barrel pieces 23b, closer to the core connection body 22, get covered by the water-blocking member 30. In this structure of the terminal-mounted electrical wire 1, the operator needs to confirm the presence of a necessary contact area between the sheath connection body 23 and the sheath end portion 12a before formation of the water-blocking member 30. This structure is, however, beneficial in that the through-hole 23c is allowed to be located as close to the core connection body 22 as possible. A smaller terminal fitting 20 of the terminal-mounted electrical wire 1 thus can be obtained.

As described above, the terminal-mounted electrical wire 1 of the embodiment has the sheath end portion 12a not projecting out of the end surfaces 23b1 of the pair of barrel pieces 23b of the sheath connection body 23 toward the core connection body 22, and this makes it possible to cover the exposed portions on the stripped portion 11a entirely with the water-blocking member 30. This structure is advantageous in keeping water from entering the gap between the exposed portion on the stripped portion 11a and the terminal fitting 20 and thus protecting the terminal-mounted electrical wire 1 from corrosion. The structure of the terminal-mounted electrical wire 1 allows the operator to determine the presence or absence of a necessary contact area between the sheath connection body 23 and the sheath end portion 12a. A proper joint therebetween is therefore maintained. As described above, the terminal-mounted electrical wire 1 of the embodiment is protected from corrosion while a proper joint is maintained between the end of the electrical wire 10 and the terminal fitting 20. These advantageous effects are exerted with the terminal fitting 20 including the sheath connection body 23 configured as above and the through-hole 23c on the sheath connection body 23.

The terminal-mounted electrical wire according to the present embodiment has the sheath end portion not projecting out of the end surfaces of the pair of barrel pieces of the sheath connection body toward the core connection body. The water-blocking member is allowed to entirely cover the exposed portions on the stripped portion, thereby keeping water from entering the gap between the exposed portion of the stripped portion and the terminal fitting and thus protecting the terminal-mounted electrical wire from corrosion. Furthermore, the terminal-mounted electrical wire allows the operator to determine the presence or absence of a necessary contact area between the sheath connection body and the sheath end portion by observation through the through-hole. A proper joint therebetween is therefore maintained. The terminal-mounted electrical wire according to the present embodiment has an improved structure to protect itself from corrosion while maintaining a proper joint of the terminal fitting to the end of the electrical wire. These advantageous effects are exerted with the terminal fitting having the sheath connection body configured as above and the through-hole on the sheath connection body.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal-mounted electrical wire, comprising:
an electrical wire including a stripped portion located on an end, and a sheath that covers a portion of a core other than the stripped portion;
a terminal fitting having a core connection body configured to be physically and electrically connected with the stripped portion, and a sheath connection body physically connected with a sheath end portion of the sheath on the end of the electrical wire, spaced from each other in an axial direction of the electrical wire; and
a water-blocking member that covers an exposed portion, outwardly exposed, of the stripped portion connected to the core connection body, wherein
the sheath connection body includes a bottom on which the sheath end portion is placed, and a pair of barrel pieces standing from respective ends, of the bottom, aligned in a direction perpendicular to the axial direction and configured to be crimped to the sheath end portion inside, the sheath end portion not projecting toward the core connection body, and
an end, of at least one of the two barrel pieces, closer to the core connection body has a through-hole through which the sheath end portion subjected to crimping is allowed to be visually observed from outside.

2. The terminal-mounted electrical wire according to claim 1, wherein
the sheath end portion and the two barrel pieces subjected to crimping are disposed such that respective end surfaces, facing the core connection body, are flush with each other.

3. The terminal-mounted electrical wire according to claim 1, wherein
the water-blocking member externally covers an end, of the two barrel pieces, closer to the core connection body, and
the through-hole is formed on a portion of an end closer to the core connection body of at least one of the two barrel pieces, the portion being not covered by the water-blocking member.

4. The terminal-mounted electrical wire according to claim 2, wherein
the water-blocking member externally covers an end, of the two barrel pieces, closer to the core connection body, and
the through-hole is formed on a portion of an end closer to the core connection body of at least one of the two barrel pieces, the portion being not covered by the water-blocking member.

5. The terminal-mounted electrical wire according to claim 1, wherein
the water-blocking member externally covers an end, of the two barrel pieces, closer to the core connection body, and
the through-hole is formed to allow the sheath end portion subjected to crimping to be visually observed from outside, at least until the end of the two barrel pieces, closer to the core connection body, is covered by the water-blocking member.

6. The terminal-mounted electrical wire according to claim 2, wherein
the water-blocking member externally covers an end, of the two barrel pieces, closer to the core connection body, and
the through-hole is formed to allow the sheath end portion subjected to crimping to be visually observed from outside, at least until the end of the two barrel pieces, closer to the core connection body, is covered by the water-blocking member.

7. A terminal fitting, comprising:
a core connection body configured to be physically and electrically connected with a stripped portion formed on an end of an electrical wire; and
a sheath connection body spaced from the core connection body in an axial direction of the electrical wire and configured to be physically connected with a sheath end portion of a sheath formed on an end of the electrical wire, wherein
the sheath connection body includes a bottom on which the sheath end portion is placed and a pair of barrel pieces standing from respective ends, of the bottom, aligned in a direction perpendicular to the axial direction and configured to be crimped to the sheath end portion inside, the sheath end portion not projecting toward the core connection body, and
an end, of at least one of the two barrel pieces, closer to the core connection body has a through-hole through which the sheath end portion subjected to crimping is allowed to be visually observed from outside.
